(19) United States
(12) Patent Application Publication
(10) Pub. No.: US 2010/0282955 A1
(43) Pub. Date: Nov. 11, 2010

(54) SEALED ROTARY MEASUREMENT SYSTEM

(75) Inventor: Alex Ka Tim Poon, San Ramon, CA (US)

Correspondence Address: Roeder & Broder LLP, 5560 Chelsea Avenue, La Jolla, CA, 92037, US

(73) Assignee: Nikon Corporation, Tokyo (JP)

(21) Appl. No.: 12/437,364

(22) Filed: May 7, 2009

(51) Int. Cl. G01D 5/34

(52) U.S. Cl. 250/231.14

(57) ABSTRACT

A measurement system (220) for measuring a rotational position of a device (214B) includes (i) a measuring assembly (224) having a first measurement subassembly (226) and a second measurement subassembly (228), and (ii) a coupling assembly (230) having a component coupler (232) and a device coupler (234). The second measurement subassembly (228) rotates relative to the first measurement subassembly (226), and the measuring assembly (224) can measure the amount of relative movement between the measurement subassemblies (226) (228) to determine the position of the device (214B). The component coupler (232) is fixedly coupled to the second measurement subassembly (228) so that rotation of the component coupler (232) results in rotation of the second measurement subassembly (228). The device coupler (234) is fixedly coupled to the device (214B). Further, the device coupler (234) interacts with the component coupler (232) in a non-contact fashion so that the rotation of the device coupler (234) results in rotation of the component coupler (232) and the second measurement subassembly (228). Moreover, the measurement system (220) can include a housing (222) that defines a sealed housing chamber (236) that encircles and encloses the measuring assembly (224) and the component coupler (232), with the device coupler (234) positioned outside the housing (222). With this design, the rotary measurement system (220) is sealed, and particularly suited for usage in dirty environments.

### BACKGROUND

Rotary motors are commonly used to move an object or alter an object. Many motors are used in conjunction with a measurement system that provides positional feedback for closed-loop control of the motor. However, dust and debris in the environment can adversely influence the operation of the measurement system, and ultimately adversely influence the operation of the motor.

### SUMMARY

The present invention is directed to a measurement system for measuring a rotational position and/or rotational rate of a device. The measurement system can include (i) a measuring assembly having a first measurement subassembly and a second measurement subassembly, and (ii) a coupling assembly having a component coupler and a device coupler. The second measurement subassembly rotates relative to the first measurement subassembly, and the measuring assembly can measure the amount of relative movement between the measurement subassemblies to determine the position of the device. The component coupler is fixedly coupled to the second measurement subassembly so that rotation of the component coupler results in rotation of the second measurement subassembly. The device coupler is fixedly coupled to the device. Further, the device coupler interacts with the component coupler in a non-contact fashion so that the rotation of the device coupler results in rotation of the component coupler and the second measurement subassembly.

Moreover, the measurement system can include a housing that defines a sealed housing chamber that encircles and encloses the measuring assembly and the component coupler, with the device coupler positioned outside the housing. With this design, the rotary measurement system is sealed, it can be relatively inexpensive to manufacture, and it can be relatively easy to integrate into the design of a precision apparatus. As a result thereof, the rotary measurement system is particularly suited for usage in dirty environments.

In one embodiment, the housing includes a housing wall that is positioned between the component coupler and the device coupler. Further, the housing can include a housing bearing that rotatable secures the second measurement subassembly to the housing, while the first measurement subassembly can be fixedly secured to the housing.

As provided herein, the measurement system can be an optical rotary encoder. With this design, one of the measurement subassemblies is an optical disk and the other of the measurement subassemblies is an optical reader.

Further, as provided herein, the coupling assembly can be a magnetic coupler. With this design, one of the couplers includes a magnet and the other of the couplers includes a material that is attracted to the magnet. Thus, the component coupler and the device coupler cooperate to define a magnetic coupler.

Additionally, the present invention is directed to a precision apparatus including a motor that rotates a device, and the measurement system having the device coupler secured to the device.

The present invention is also directed to a method for measuring a rotational position of a device that includes the steps of: (i) providing a housing; (ii) fixedly securing a first measurement subassembly to the housing; (iii) rotatable securing a second measurement subassembly to the housing; (iv) fixedly coupling a component coupler to the second measurement subassembly; and (v) fixedly coupling a device coupler to the device. In this embodiment, the device coupler interacts with the component coupler in a non-contact fashion so that the rotation of the device coupler results in rotation of the component coupler and the second measurement subassembly.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified top illustration of an apparatus having features of the present invention;

FIG. 2 is a simplified side view of a portion of a device and a measurement system, in partial cut-away having features of the present invention;

FIG. 3 is a simplified perspective view of a portion of the measurement system of FIG. 2;

FIG. 4 is a simplified perspective view of a portion of the measurement system of FIG. 2; and

FIG. 5 is a simplified perspective view of another portion of the measurement system of FIG. 2.

### DESCRIPTION

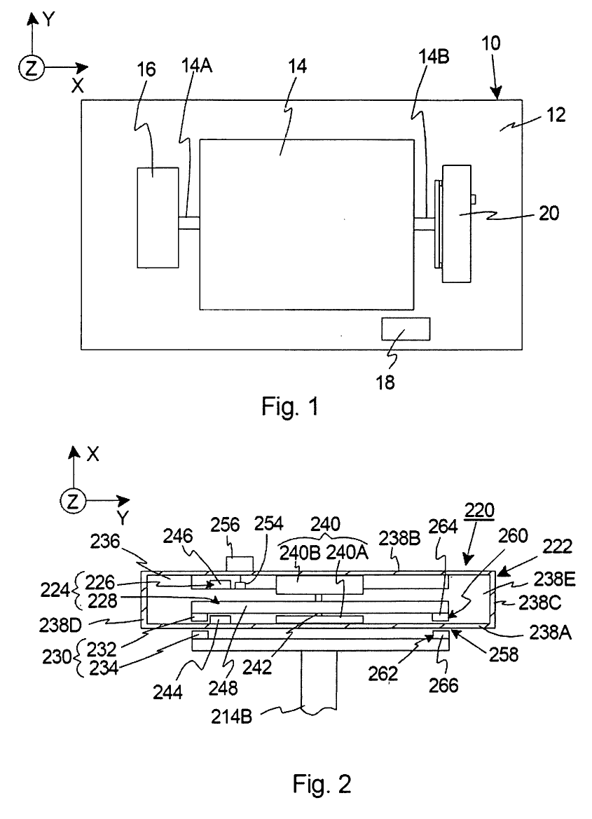

FIG. 1 illustrates one non-exclusive, simplified embodiment of a precision apparatus 10. The design of the apparatus 10 and the type of apparatus 10 can be varied. For example, the apparatus 10 can be used in manufacturing equipment, technical equipment, measurement equipment, scientific instruments, robots, vehicles or other machines. In FIG. 1, the apparatus 10 includes an apparatus frame 12, a mover 14, an object 16 (illustrated as a cylinder) that is rotated, a control system 18 and a rotary measurement system 20. Alternatively, the apparatus 10 can be designed to have more or fewer components than that illustrated in FIG. 1.

As provided herein, in certain embodiments, the rotary measurement system 20 is sealed and is uniquely designed to be relatively inexpensive to manufacture, and relatively easy to integrate into the design of the apparatus 10. As a result thereof, the rotary measurement system 20 is particularly suited for usage in dirty environments.

A number of Figures include an orientation system that illustrates an X axis, a Y axis that is orthogonal to the X axis, and a Z axis that is orthogonal to the X and Y axes. It should be noted that these axes can also be referred to as the first, second, and third axes.

The apparatus frame 12 is rigid and supports the other components of the apparatus 10.

The mover 14 is coupled to the object 16 and the rotary measurement system 20. The mover 14 can be any type of actuator. In FIG. 1, the mover 14 includes a rotating first output 14A that is coupled to and rotates the object 16 about the X axis, and a rotating second output 14B that is coupled to and rotates a portion of the measurement system 20 about the X axis. In this embodiment, each of the outputs 14A, 14B is a solid, cylindrical shaft. Alternatively, for example, the mover 14 can be designed to have a single output and the portion of the measurement system 20 is coupled to the object 16 or the single output.

The object 16 being rotated can be any type of device. As non-exclusive examples, the object 16 being rotated can be a robotic arm, a wheel of a vehicle, a precision manufacturing tool, or a precision manufacturing tool, or a washer drum in a washing machine appliance.

The control system 18 directs current to the mover 14 and controls the operation of the apparatus 10. For example, the control system 18 can receive rotational position information from the measurement system 20 and can control the mover 14 to accurately position the object 16. For example, the control system 18 can include one or more processors.

The measurement system 20 measures the rotational position and/or rotational rate of a device (e.g. the second output 14B and/or the object 16), and provides rotational position information relating to the rotational position of the device to the control system 18. With this design, in certain embodiments, the mover 14 can be operated in closed-loop fashion. In the embodiment illustrated in FIG. 1, a portion of the measurement system 20 is fixedly secured to the second output 14B, and rotates with the second output 14B, and a portion of the measurement system 20 is fixedly secured to the apparatus frame 12. Alternatively, the measurement system 20 can be used to monitor the rotational position of another device.

FIG. 2 is a simplified side view of a portion of a device 214B (e.g. the second output of the mover 14 illustrated in FIG. 1) and a measurement system 220, in partial cut-away, having features of the present invention. In this embodiment, the measurement system 220 includes (i) a housing 222, (ii) a rotary measuring assembly 224 including a first measurement subassembly 226 and a second measurement subassembly 228, and (iii) a coupling assembly 230 including a component coupler 232 and a device coupler 234.

The housing 222 defines a sealed housing chamber 236 that encircles and encloses the measuring assembly 224 and the component coupler 232 of the coupling assembly 230. In one non-exclusive embodiment, the housing 222 is shaped somewhat similar to a rectangular shaped box that includes six, generally flat housing walls 238A-238 (only five are illustrated in FIG. 2). In this embodiment, one of the housing walls 238A is positioned between the component coupler 232 and the device coupler 234.

The housing walls 238A-238E can be made of any material that is rigid, non-magnetic, and that does not influence the operation of the coupling assembly 230. Non-exclusive examples of suitable materials for the housing walls 238A-238E include glass, plastics, or metals.

In FIG. 2, the first measurement subassembly 226 is fixedly secured to one of the housing walls 238B, while the second measurement subassembly 228 and the component coupler 232 are rotatable coupled to the housing 222. In this embodiment, the housing 222 can include a bearing assembly 240 and a component shaft 242 that rotatable secure the second measurement subassembly 228 and the component coupler 232 to the housing walls 238A, 238B. More specifically, in this embodiment, the bearing assembly 240 includes a lower housing bearing 240A that is retained by the housing wall labeled 238A, and an upper housing bearing 240B that is spaced apart from the lower bearing 240A and that is retained by the housing wall labeled 238B. Further, in this embodiment, (i) the component shaft 242 extends between and is retained by the housing bearings 240A, 240B, and (ii) the second measurement subassembly 228 and the component coupler 232 are secured to component shaft 242. With this design, the second measurement subassembly 228 and the component coupler 232 are free to rotate relative to the first measurement subassembly 228 and the housing walls 238A-238E.

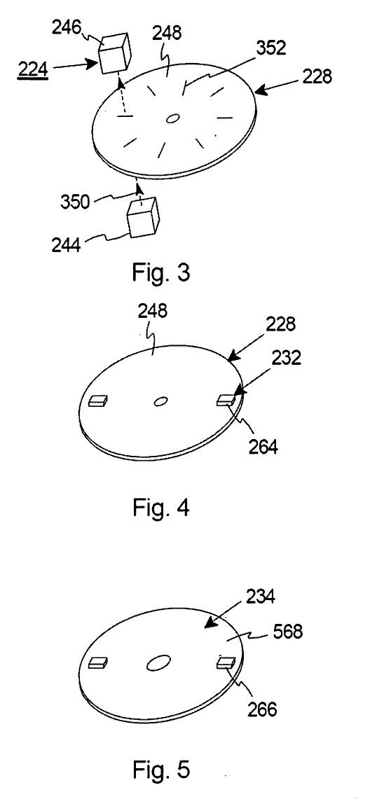

The measuring assembly 224 provides the rotational position information. In one embodiment, the measuring assembly 224 is a rotational optical encoder that includes the first measurement subassembly 226 and the second measurement subassembly 228. FIG. 3 is a simplified perspective view of the first measurement subassembly 226 and the second measurement subassembly 228. In this embodiment, (i) one of the measurement subassemblies 226, 228 includes a light source 244 and an optical reader 246, and (ii) the other of the measurement subassemblies 228, 226 includes an optical disk 248.

In the embodiment illustrated in FIG. 3, the first measurement subassembly 226 includes the light source 244 and the optical reader 246, while the second measurement subassembly 228 includes the optical disk 248. Alternatively, the first measurement subassembly 226 can include the optical disk 248, and the second measurement subassembly 228 can include the light source 244 and the optical reader 246. However, this alternative design would be more complicated because the light source 244 and the optical reader 246 would be rotating.

In FIG. 3, the light source 244 and the optical reader 246 are spaced apart with the optical disk 248 positioned between the light source 244 and the optical reader 246. Further, in this embodiment, the light source 244 and the optical reader 246 are fixedly secured to the housing 222 as illustrated in FIG. 2. Moreover, as illustrated in FIG. 3, the light source 244 generates one or more beams 350 that are directed at the optical disk 248 and subsequently to the optical reader 246.

Additionally, in FIG. 3, the optical disk 248 includes a plurality of encoder marks 352 (only a few are illustrated) that are distributed around the disk. Further, in this embodiment, the optical disk 248 is fixedly secured to the component shaft 242 as illustrated in FIG. 2.

With this design, the optical disk 248 rotates relative to the light source 244 and the optical reader 246, and the measuring assembly 224 measures the amount of relative movement and/or rotation rate between the optical disk 248 and the optical reader 246 by counting the encoder marks 352. Alternatively, one or all of the encoder marks 352 can have a unique design that allows the optical reader 246 to specifically identify each of the encoder marks 352. This feature allows the measuring assembly 224 to determine rotational position without counting encoder marks 352.

Additionally, referring back to FIG. 2, the measuring assembly 224 can include a measurement control system 254 that receives information from the optical reader 246 and that determines the position and/or rotational rate of the device 214B. The measurement control system 254 can include one or more processors. In FIG. 2, the measuring assembly 224 also includes an electrical connector 256 that allows the measuring assembly 224 to be electrically connected to the rest of the apparatus 10 (illustrated in FIG. 1).

The coupling assembly 230 couples the device 214B to the measuring assembly 224. In one embodiment, the component coupler 228 and the device coupler 230 are spaced apart a coupler gap 258 and one of the housing walls 238A is positioned in the coupler gap 258.

In one embodiment, the coupling assembly 230 is a magnetic type coupler. In this embodiment, one of the couplers 232, 234 includes a magnet assembly 260, and the other of the couplers 234, 232 includes an attracted assembly 262. For example, the component coupler 232 can include the magnet assembly 260, and the device coupler 234 can include the attracted assembly 262. Alternatively, the component coupler 232 can include the attracted assembly 262, and the device coupler 234 can include the magnet assembly 260. With both arrangements, the component coupler 232 and the device coupler 234 are coupled together in a non-contact fashion. As a result thereof, rotation of the device coupler 234 results in equal rotation of the component coupler 232 and the second measurement subassembly 228.

The design of the magnet assembly 260 and the attracted assembly 262 can be varied pursuant to the teachings provided herein. In the embodiment illustrated in FIG. 2, the magnet assembly 260 includes two spaced apart magnets 264 and the attracted assembly 262 includes two spaced apart attracted members 266. Alternatively, the magnet assembly 260 can include more or fewer than two magnets 264 and the attracted assembly 262 can include more or fewer than two attracted members 266. Typically, the number of attracted members 266 corresponds to the number of magnets 264.

In one embodiment, each of the magnets 264 is a permanent magnet. Alternatively, one or more of the magnets 264 can be an electromagnet.

Further, each of the attracted members 266 can be made of a material that is attracted to the magnet 264. Suitable materials for the attracted members 266 include ferromagnetic materials such as iron, nickel, cobalt, and alloys thereof.

FIG. 4 is a bottom perspective view of the optical disk 248 and the component coupler 232. This Figure illustrates that the magnets 264 are fixedly secured to the bottom of the optical disk 248. Alternatively, the component coupler 232 can be secured to the second measurement subassembly 226 in another fashion.

FIG. 5 is a top perspective view of the device coupler 234. In this embodiment, the device coupler 234 includes a disk shaped device flange 568 that is secured to the device 214B (illustrated in FIG. 2) and the attracted members 266 that are secured to the flange 568. Alternatively, the device coupler 234 can be secured to the device 214B in another fashion.

While the particular system 20 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A measurement system for measuring a rotational position or rotational rate of a device, the measurement system comprising:
a measuring assembly that includes a first measurement subassembly and a second measurement subassembly that rotates relative to the first measurement subassembly; and
a coupling assembly including a component coupler that is fixedly coupled to the second measurement subassembly so that rotation of the component coupler results in rotation of the second measurement system, and a device coupler that is adapted to be coupled to the device, the device coupler interacting with the component coupler in a non-contact fashion so that the rotation of the device coupler results in rotation of the component coupler and the second measurement subassembly.

2. The measurement system of claim 1 further comprising a housing that encircles the measurement assembly and the component coupler, the housing including a housing wall that is positioned between the component coupler and the device coupler.

3. The measurement system of claim 2 wherein the housing defines a sealed housing chamber that encloses the measuring assembly and the component coupler.

4. The measurement system of claim 1 wherein the housing includes a housing bearing that rotatable secures the second measurement subassembly to the housing, and wherein the first measurement subassembly is fixedly secured to the housing.

5. The measurement system of claim 1 wherein one of the measurement subassemblies includes an optical disk and the other of the measurement subassemblies includes an optical reader.

6. The measurement system of claim 1 wherein one of the couplers includes a magnet and the other of the couplers includes a material that is attracted to the magnet.

7. The measurement system of claim 6 wherein the component coupler and the device coupler cooperate to define a magnetic coupler.

8. A precision apparatus including a motor that rotates a device, and the measurement system of claim 1 having the device coupler secured to the device.

9. A measurement system for measuring a rotational position or a rotational rate of a device, the measurement system comprising:
a housing that defines a housing chamber;
a measuring assembly positioned in the housing chamber, the measuring assembly including a first measurement subassembly that is secured to the housing, and a second measurement subassembly that rotates relative to the first measurement subassembly, and wherein one of the measurement subassemblies includes an optical disk and the other of the measurement subassemblies includes an optical reader; and
a magnetic coupling assembly including (i) a component coupler that is fixedly coupled to the second measurement subassembly so that rotation of the component coupler results in rotation of the second measurement system, the component coupler being positioned within the housing chamber, and (ii) a device coupler that is adapted to be coupled to the device, the device coupler interacting with the component coupler in a non-contact fashion so that the rotation of the device coupler results in rotation of the component coupler and the second measurement subassembly, wherein the device coupler is positioned outside the housing chamber.

10. The measurement system of claim 9 wherein the housing including a housing wall that is positioned between the component coupler and the device coupler.

11. The measurement system of claim 9 wherein the housing includes a housing bearing that rotatable secures the second measurement subassembly to the housing.

12. The measurement system of claim 9 wherein one of the couplers includes a magnet and the other of the components includes a material that is attracted to the magnet.

13. A precision apparatus including a motor that rotates a device, and the measurement system of claim 9 having the device coupler secured to the device.

14. A method for measuring a rotational position or a rotational rate of a device, the method comprising the steps of:
providing a housing;
fixedly securing a first measurement subassembly to the housing;
rotatable securing a second measurement subassembly to the housing;
fixedly coupling a component coupler to the second measurement subassembly so that rotation of the component coupler results in rotation of the second measurement subassembly; and
fixedly coupling a device coupler to the device, wherein the device coupler interacts with the component coupler in a non-contact fashion so that the rotation of the device coupler results in rotation of the component coupler and the second measurement subassembly.

15. The method of claim 14 wherein the step of providing a housing includes providing a housing that defines a housing chamber that encircles the measurement subassemblies and the component coupler, and wherein the housing including a housing wall that is positioned between the component coupler and the device coupler.

16. The method of claim 14 wherein one of the measurement subassemblies includes an optical disk and the other of the measurement subassemblies includes an optical reader.

17. The method of claim 16 wherein one of the couplers includes a magnet and the other of the couplers includes a material that is attracted to the magnet.

18. The method of claim 14 wherein one of the couplers includes a magnet and the other of the couplers includes a material that is attracted to the magnet.

19. A precision assembly comprising: a rotating device, and a measurement system that measures the rotational position or rotational rate of the device by the method of claim 14.
